(19) United States
(12) Patent Application Publication
(10) Pub. No.: US 2004/0165090 A1
(43) Pub. Date: Aug. 26, 2004

(54) Auto-focus (AF) lens and process

(76) Inventor: Alex Ning, San Marcos, CA (US)

Correspondence Address: JAMES F KIRK, 16365 MARUFFA CIRCLE, HUNTINGTON BEACH, CA, 92649-2134, US

(21) Appl. No.: 10/778,785

(22) Filed: Feb. 13, 2004

Related U.S. Application Data
(60) Provisional application No. 60/447,848, filed on Feb. 13, 2003.

(51) Int. Cl. H04N 5/335

(52) U.S. Cl. 348/272

(57) ABSTRACT

An Auto-focusing Lens system that provides a positive or negative drive command signal and distance information to a Lens Movement Control System to initially move the lens in the correct direction to obtain best focus position without searching. The lens has a pre-determined amount of longitudinal chromatic aberrations (LCA). The lens focuses the image on an imager. The imager senses the light on the focal plane and provides an array of intensity values for the primary colors of Red (R), Green (G) and Blue (B) from a region of interest (ROI) on the imager that are used to calculate R, G and B image quality signals for the R, B and G wavelengths and uses the respective values of the R, B and G image quality signals to determine in which of three regions of focus distance the lens is residing. A look-up table for R, G and B image quality signal difference quotients versus lens position provides a lens movement distance signal.

This application claims priority from U.S. Provisional Application 60/447,848 filed Feb. 13, 2003 for an AUTO-FOCUS LENS AND PROCESS IMAGING MODULE and having a common inventor

### BACKGROUND OF THE INVENTION

1. Field of the Invention

The Auto-focus (AF) lens and process is typically related to the field of digital cameras.

2. Description of Related Art

In a camera, a lens captures the image of a distant object and focuses the image of the object onto an image plane. In a conventional auto-focus (AF) lens and process system, the system automatically moves the lens and focuses the image on the image plane without the assistance of the operator. A conventional AF lens processes information from the image plane electronics and adjusts the position of the lens on the optical axis to maximize the luminance contrast of the image formed on the image plane.

The luminance contrast output signal alone, as processed by a conventional auto-focus system, does not provide an initial direction for lens movement nor information on how far the lens must be moved to optimize the luminance contrast signal. A closed loop search is conducted to find the best focus position which requires multiple image acquisition. This search takes a significant amount of time to complete.

The present invention provides direction and distance control signals that allow the lens to be driven to the best focus position with only one image acquisition and without a closed loop search.

### BRIEF SUMMARY OF THE INVENTION

A lens focuses the image of a target object onto an electronic imager(s). The initial position of the lens may not be optimal for the given object distance. The overall image will be a little blurry at this lens position. A first object of the AF lens and process is to provide a Lens Movement. Control System with a positive or negative movement command signal so that the lens is moved initially in the correct direction to obtain a best focus position.

A second object of this invention is to provide an improved AF process that provides initial directional information to the Lens Movement Control System to move the lens in the direction of best focus without a search.

And another object of the invention is to provide an improved AF lens and process that provides both the directional information and a distance signal characterizing the distance that the lens has to be moved to obtain proper focus. The directional information and the distance signal are coupled to the Lens Movement Control System.

These objects are achieved in a preferred embodiment of the invention AF lens and process having a lens that acquires a color image. The lens has a predetermined amount of longitudinal chromatic aberrations (LCA). The LCA of a lens indicates how the focal length of the lens changes with the wavelength of light passing through the lens. The lens forms an image of the object on an imager or detector array. The imager senses the light on its focal plane and provides an array of pixel intensity values for the primary colors of Red (R), Green (G) and Blue (B). The embodiment further comprises a means for calculating R, G and B image quality signals for the respective data arrays of R, G and B. The invention auto-focusing lens and system compares the values of the R, G and B image quality signals with each other to determine which is the largest, next to largest and smallest value. The invention system then uses the amplitude relationships to output a positive direction command to drive the lens in a positive direction if the B image quality signal is greater than the R image quality signal and a negative direction command if the R image quality signal is greater than the B image quality signal.

In yet a second embodiment of the AF lens and process, an array of lens focus position locations are stored in a memory that corresponds to values of the (R−B)/G image quality signal difference quotient, where the symbol R, B and G represent the values of R, B and G image quality signals.

In operation, as a first image is formed on the imager, present values of R, G and B image quality signals are developed. An array of lens focus position locations were previously stored along with corresponding values of the (R−B)/G image quality signal difference quotient for each respective lens focus position location. The process then takes a present value of (R−B)/G and finds the closest match in the array table and uses the corresponding lens focus position location to determine the distance that the lens must be moved from its present location to the new location corresponding to present value image quality signal difference quotient.

### BRIEF DESCRIPTION OF THE DRAWINGS

FIG. 1. Is a graph of the modulation transfer function (MTF) at 50 cycle/mm for Red, Green and Blue wavelength entering a lens and being focused on an image plane. The graph is plotted as a function of focus shift.

FIG. 2 is a functional block diagram of the present invention.

FIG. 3a is a logic or process flow chart for the determination of the initial direction of lens movement;

FIG. 3b is a logic or process flow chart for a continuation of the focus process to fine focus the lens and to test to determine if the option of a DISTANCE ROUTINE should be accessed and performed;

FIG. 4. is a graph of the ratio of the difference between the values of Red (R) and Blue (B) divided by Red (R) image quality signals and the Focus Shift distance in mm of FIG. 1 where the MTF values at R, G and B are used as the “image quality signals”.

FIG. 5 is a flow chart for the process and system for determining the distance that the lens has to be moved for proper focus.

FIG. 6 is a schematic analog circuit for calculating the image quality signal quotient (R−B)/G.

### DETAILED DESCRIPTION OF THE INVENTION

In the present invention, the lens system that is used must have a predetermined amount of longitudinal chromatic aberrations (LCA). The lens is designed using optical materials that permit tailoring of an LCA; however, it is also possible to add a dispersive optical element to an existing LCA-free lens to obtain the desired or predetermined LCA. The use of a dispersive element improves the control of the LCA obtained for a particular lens design.

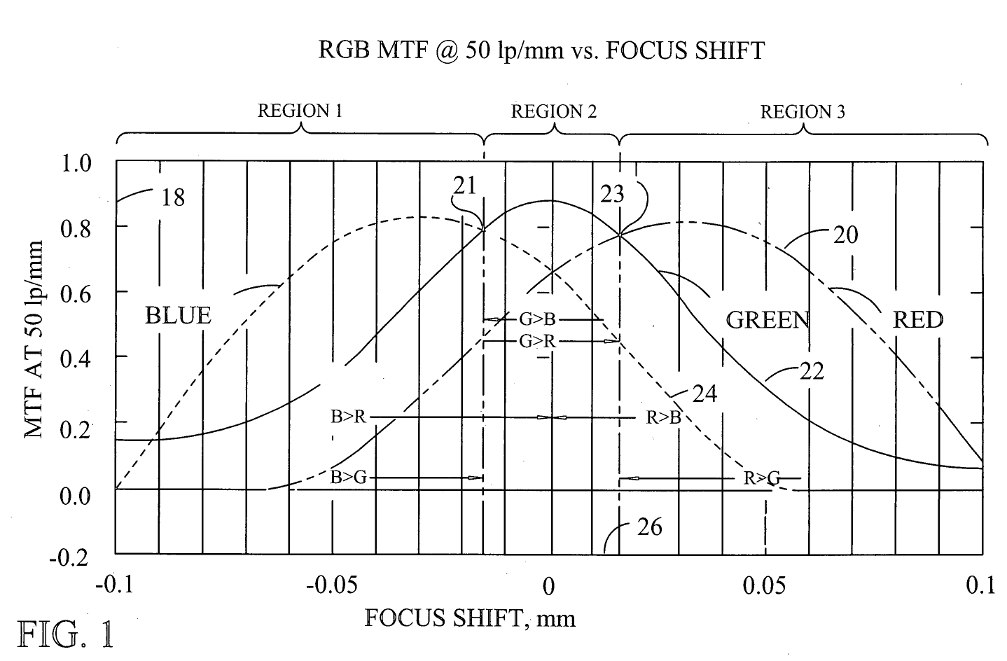

FIG. 1 shows the LCA properties of an actual lens design. The three curves show the spread in focus shift that is associated with the wavelengths for Red, R, 20, Green, G, 22 and blue, B, 24 wavelengths or components of light that will be processed into R, G and B image quality signal values. The independent variable 26 has the dimension of millimeters of lens movement. The dependent variable is an indication of CONTRAST, known as the modulation transfer function (MTF) at 50 lp/mm (line pairs per millimeter) spatial frequency.

Longitudinal chromatic aberration is usually considered undesirable for high performance optics. However in this application, we will use the LCA to our advantage to provide the directional signal, and to predict the amount of lens movement required for the lens to be in focus.

In an under-corrected LCA lens, the blue component of the spectrum is focused at a point closest to the lens, and the red component of the spectrum is focused at a point farthest from the lens. The green component of the spectrum has its focal point approximately half way between the red and blue focal points characterized by the peaks of the curves. An example of an under-corrected LCA lens is shown in the graph of FIG. 1. The contrast (or Modulation Transfer Function, or MTF at 50 cycle/mm) of a real lens at each R, B and G wavelength is plotted as functions of the shift in focus. The best focus position is located at the point at which the G wavelength MTF is at this peak. In an over-corrected LCA lens, the order of wavelength peaks or focal points is reversed.

In a single imager system, a color filter array (CFA) (not shown) is used in front of the photo-detectors. Commonly used CFA patterns are primary RGB Bayer pattern or the CMY, Complimentary Color patterns. In multiple imager systems, three imagers are used, one for each color component with a corresponding color filter in the optical path of each imager. The imager 32 or imagers are capable of generating images at three separate R, G and B wavelengths.

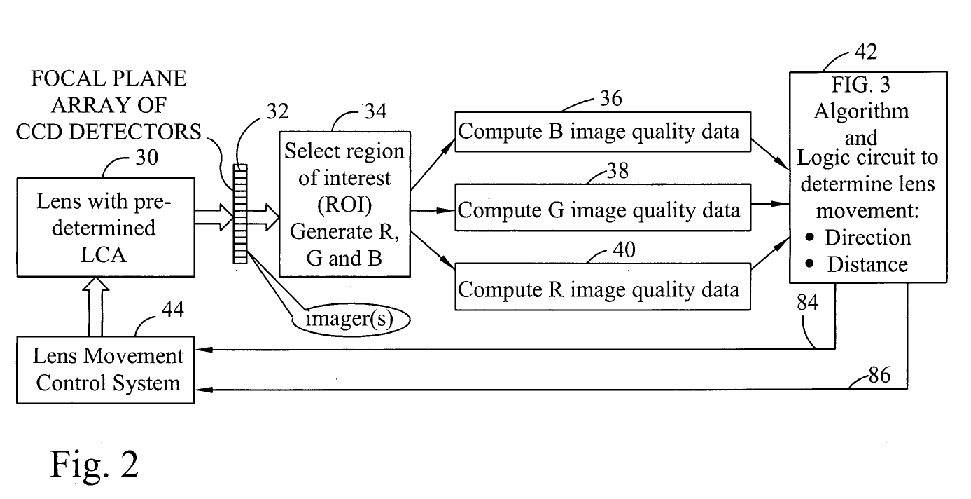

FIG. 2 is a block diagram of an embodiment of the present invention. Block 30 represents the lens or objective characterized as having a predetermined LCA. In a digital imaging system, an electronic imager 32, consists of an array of photo-detectors (pixels). The imager forms a focal plane for the lens and captures the image of the object. To obtain a color image, the imager 32, or imager(s) must be capable of acquiring the images at three different wavelengths corresponding to the primary colors of human vision.

FIG. 2 shows the lens 30 focusing the target image on at least one imager or focal plane array 32. Block 34 represents the process of sampling each of the respective wavelength data from a predetermined region of interest (ROI) on the imager.

Blocks 36, 38 and 40 represent the steps of concurrently computing the R, G and B image quality signal values from the Red, R, Green, G and Blue data. A DSP (digital signal processor) is used to analyze the contrast information contained in each of the R, G and B image plane data and provide R, G and B image quality signal values.

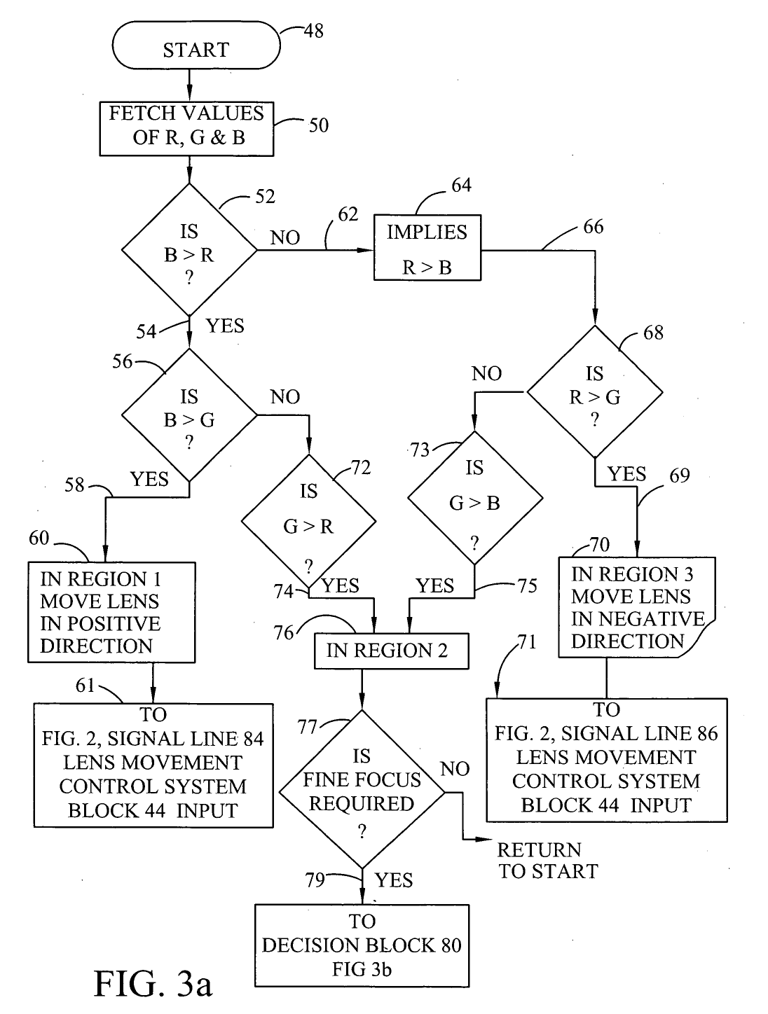

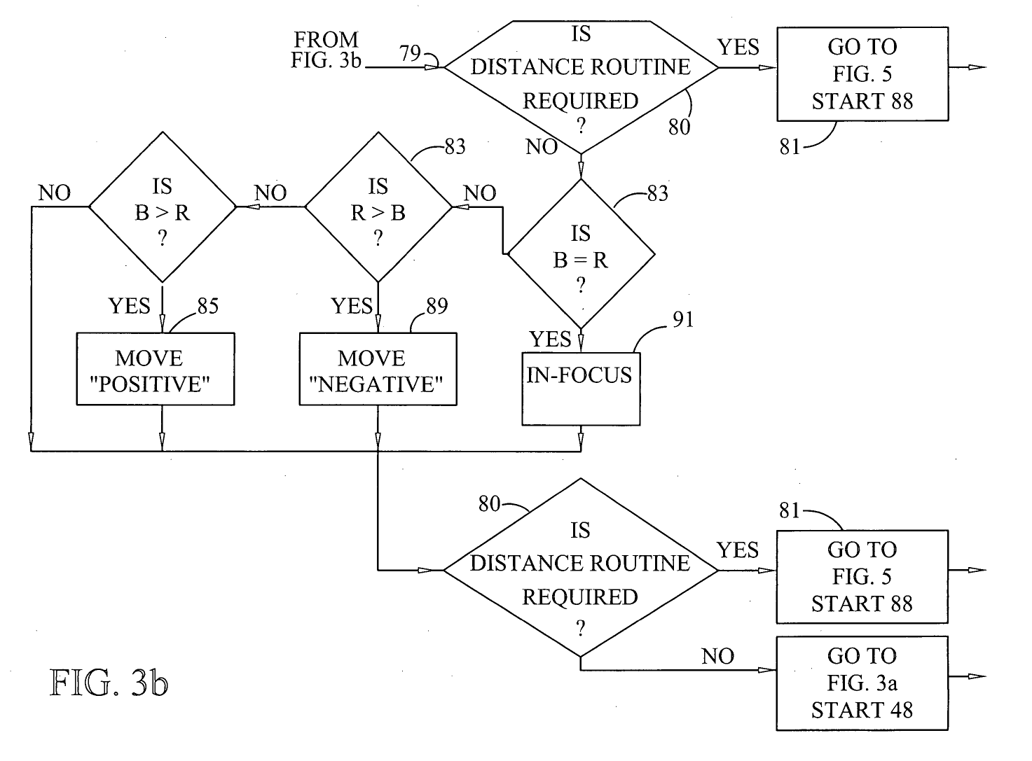

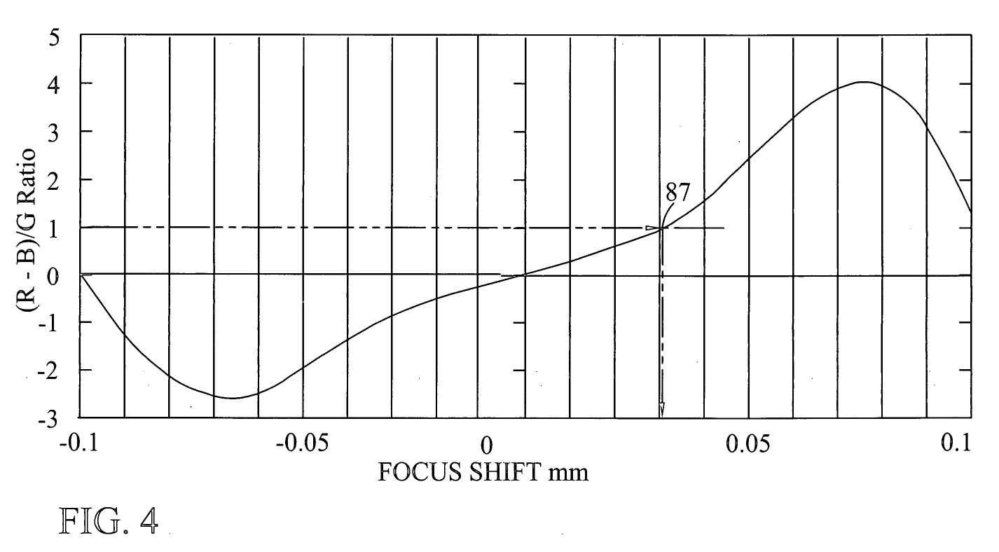

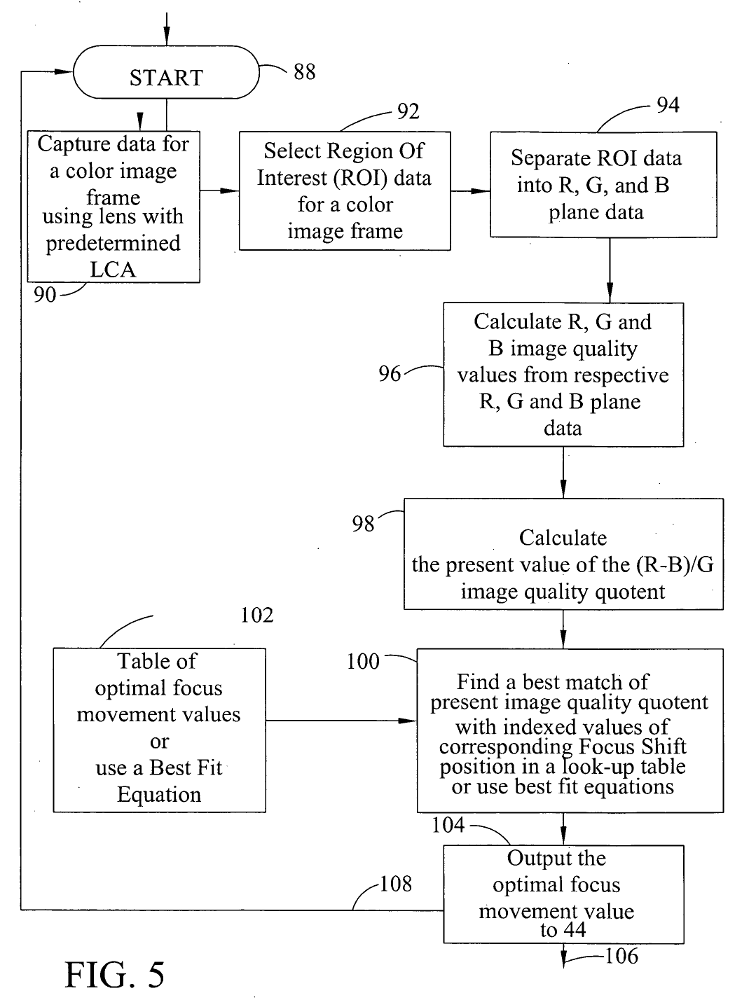

Block 42 represents the use of an algorithm and/or logic circuit such as that depicted in FIGS. 3a, 3b, and FIG. 5 to generate a command to move the lens in a positive direction or in a negative direction. Using the contrast values or R, G and B image quality signal values for each color component in the ROI image, block 42 provides a positive or negative direction command signal. FIG. 4 is a derivative of data relating to FIG. 1. FIG. 5 will use information from FIG. 4 in an optional process to estimate the amount of lens movement required to be in focus based on the LCA properties of the lens.

Block 42 represents the algorithms and processes of FIGS. 3a, 3b, and 5 which generate direction and distance signals for lens movement. The direction and distance signals are coupled to the Lens Movement & Control System represented in FIG. 2 by block 44. Signal lines 84, 86 couple left and right direction signals and signal line 106 couples a distance signal from block 43 to the Lens Movement & Control System, block 44 which drives the lens in the selected direction in response to the command signals that are received.

The process begins with a data stream obtained from the imager(s) 32. The data stream is a sequence of intensity values for R, G and B pixels that are read out of the imager 32 and processed as follows. First, a ROI (region of interest) is selected. The ROI is a subset of the entire image or frame data array for the image. The ROI selected, for example, can be the central 10% square area of the entire image. Such a choice might be a built-in design feature. With added software, the ROI could be made adaptive as a function of the scene to be captured or other parameters. The raw image intensity values over the ROI is then segregated into its R, G and B image or pixel intensity data signals. Each color component is then further processed, using an elected algorithm, to generate a numeric value that corresponds to R, G and B image quality signals for the ROI.

Numerous algorithms or definitions for the R, G and B image quality values are possible. The value can be the contrast (MTF) for the image at a specific spatial frequency, or the average contrast over a range of spatial frequencies. The value could also be the edge sharpness, or a combination of the edge sharpness and the MTF at the image over a range of spatial frequencies. The principal requirement of the elected algorithm is that the numeric values produced for the R, G and B image quality signals must be related to the image quality at wavelengths over the range of interest. Detailed methods for computing image quality signals can be found in books such as “Fundamentals of Electronic Imaging Processing” by Authur R. Weeks, Jr. IEEE press, 1996.

Brackets at the top of FIG. 1, divided the range of the independent variable into REGION 1, REGION 2 AND REGION 3. Region 1: extends from the left vertical axis 18 to the intersection of the B and G curves at 21. Region 2:extends from the intersection of the B and G curves to the intersection of the G and R curves 23. The best focus position is within this region. Region 3:extends from the point where G and R curves intersect 23 to the right most limit of the graph. The numeric value produced for the R, G and B image quality signals varies with the focus shift in a manner consistent with that shown in FIG. 1. The image quality value assigned to R represents the image quality value of the red image. The image quality value assigned to the variable B represents the image quality value of the blue image and G represents the image quality value for the green image.

FIG. 3a shows a logic process for generating directional signal information that will be coupled to the lens movement control system 44 via signal lines 84 and 86. The process begins at FIG. 3a at START bubble 48 and is followed with the step of fetching the values of the R, G and B image quality signals per block 50. The process then advances to decision or comparison block 52 to determine if B>R. If the value of B is greater than R, the result is YES and the process advances along path 54 to comparison block 56 to test if B>G. If the answer is YES again, the process uses path 58 to move to block 60 acknowledging that the lens is in region 1 and should be moved in the positive direction toward region 2.

The increment of movement is determined by the property of the Lens Movement Control System 44. The lens should continue to move in the positive direction until it reaches region 2.

Referring again to FIG. 3a, if the test of decision block 52 resulted in a NO decision, the result would advance along path 62 to path 66 via block 64. Block 64, by inference, recognizes the implication that if B is not greater than R then R>B. Signal path 66 then leads to decision block 68 to test if R≧G.

If the test of decision block 68 results in a YES, the process uses path 69 to pass to block 71 acknowledging that the lens is in region 3. The process then advances to the next block where drivers are instructed to provide a control or drive signal to block 44 on FIG. 2 to move the lens in a negative direction toward region 2. The increment of movement required is again determined by the property of the lens and the Movement Control System 44. The lens should continue to move in a negative direction until it reaches region 2.

If the result of the tests of decision blocks 56 and 68 were NO, then G>R and G>B and, the lens is in region 2. The best focus is therefore nearby. Some applications with less demanding requirements or performance requirements permit the AF lens and process to accept the focus position obtained once the lens is in Region 2 and return to the start bubble 48.

However, if further AF accuracy is desired, the R and B wavelength can be carefully selected so that the R and G signal amplitudes cross at a point where the amplitude of the G signal is at maximum as shown in FIG. 1 at “0” on the axis of the independent variable. In this case, if B>R the lens movement control system 44 is commanded to move the lens further in the positive direction until B=R. If R>B, the lens movement control system 44 is commanded to move the lens further in the negative direction until B=R. Now the lens is at the best focus where G is maximized.

The above algorithm is obtained by the process of FIG. 3b for fine focusing. If the process is required to obtain a better focus, the process follows the YES signal line from block 72 to the decision block 80 on FIG. 3b where the question “IS DISTANCE ROUTINE REQUIRED”. Block 80 appears again at the bottom of FIG. 3b. Block 80 can be positioned at any of several positions on FIGS. 3a and 3b. However, if the decision is made at the design or model level, the decision can be replaced with a hard wired YES or NO and the decision block 80 can thereafter be eliminated. If the decision is made to not require a DISTANCE ROUTINE, the process will branch or jump to the beginning of the direction routine at start bubble 48 on the flow chart of FIG. 3a. If the decision is made to require a DISTANCE ROUTINE, the process will branch or jump to the beginning of the distance routine at start bubble 88 on the flow chart of FIG. 5. The combination of the fine focus routine of FIG. 3b with the distance routing of FIG. 5 provides an improvement upon the current luminance contrast process since it provides fine directional information in combination with distance information to the Lens

Movement Control System 44 on FIG. 2 will help to reduce the time to find the optimized focus point. It is possible to improve the above logic further by generating not just directional information but also the amount of lens movement required to be at the G peak . Upon executing the fine focus routine of FIG. 3b, the Movement Control System 44 adjusts the magnitude of the positive and negative drive signals to a lower level than used initially since the distance that the lens will move is reduced. The term “nudge” is used to explain that the magnitude of the impulse or torque command is substantially reduced.

Once the focus obtained is inside region 2, a decision is made to require or not require a fine focus which would require finer lens movement steps leading to a peak in the value of the G image quality signal. Once the lens is in region 2, it is also possible to use the algorithm of FIG. 5 to calculate the exact distance required to be in the best focus.

As a first step in the fine focus process and fine position process, the ratios of R/G and B/G are calculated. The combination of R/G and B/G ratios uniquely determines the absolute position of the lens. From this, it is possible to move the lens to the best focus position in one operation.

The value of the graph of FIG. 4 is therefore the (R−B)/G ratio vs. Focus Shift of FIG. 1. This implies that for each (R−B)/G value, there exists a unique focus shift. So if the (R−B)/G ratio is calculated, one can deduce the exact amount of focus shift required from the graph of FIG. 4.

FIG. 4 shows the dependent variable is R/G−B/G or (R−B)/G where R, B and G are image quality signals as a function of FOCUS SHIFT distance in mm. FIG. 4 uses data from the same lens used for FIG. 1. The curve of FIG. 4 is seen to be monotonic over a significant range of distances and particularly over the central portion of the FOCUS SHIFT axis. The curve of FIG. 4 is centered at the best focus position. The distance and direction that the lens must be moved is read from the curve of FIG. 4 by computing the present value of the difference ratio of (R−B)/G from the image quality value signals, finding the same value on the independent variable axis of FIG. 4, the vertical axis, tracing a horizontal line from the value of the image quality signal quotient calculated to intercept the curve of FIG. 4, and then reading the value of the focus shift distance required on the independent variable axis below the intercept point. Assume that the present value of the (R−B)/G image quality signal difference quotient is 1.0, referring to FIG. 4, the intercept point 87 is found. The intercept point 87 in this example corresponds to a FOCUS SHIFT value of approximately 0.031 mm. Since the value on the independent variable axis is positive, the lens position should be driven in a negative direction through a distance of 0.031 mm to obtain a best focus position.

The example shows that the exact distance that the lens must be moved or the exact focus shift of the initial lens position as well as the direction that the lens must be moved is available from information on the graph of FIG. 4. It should be understood that the data for the graph of FIG. 4 is related to the design of the lens and can be obtained empirically from a representative lens from a lot or possibly by modeling. Once an array of image quality signal difference quotient data is available for a family of points on the independent variable axis, the array of the (R−B)/G image quality signal difference quotient values is stored in a memory and used as a look-up table for the FOCUS SHIFT distance for any present value of the (R−B)/G image quality signal difference quotient from a single or even initial image capture. The data relating to the curve of FIG. 4 can be stored in the memory of the processing system either as a look-up table or as a set of coefficients of the best-fit equation. After a present value of the (R−B)/G image quality signal difference quotient ratio is calculated, a processor can then calculate or look up the exact amount of focus shift in millimeters.

Once available, the distance and direction information is sent to the Lens Movement Control System 44 via signal paths 84, 86 and 106 to make the appropriate lens adjustment for best focus.

The curve of FIG. 4 is non-monotonic if the initial position of the lens is too far from the center position of best focus, i.e. where the independent variable has a value of zero, For this process to work, the initial lens position or distance from the focal plane or imager is adjusted to be near the center position for best focus.

In the lens examples discussed in connection with the graphs of FIG. 1 and FIG. 4, if only directional information is desired, at least one of the B or R values must be significantly greater than 0. If one wishes to calculate the exact amount of lens movement, the absolute present value of both the R and B image quality values must be >0. The distance process works over a narrower range of focus shift.

If the initial position of the lens is too great for the distance calculation process to work, the direction only algorithm is initially used to move the lens into its functional range. After the lens is moved into its functional range a second image is generated and used with the distance algorithm to complete the final movement process. Therefore, the initial lens focus calibration need only be set to be within the functional range of the direction algorithm process as the camera is manufactured.

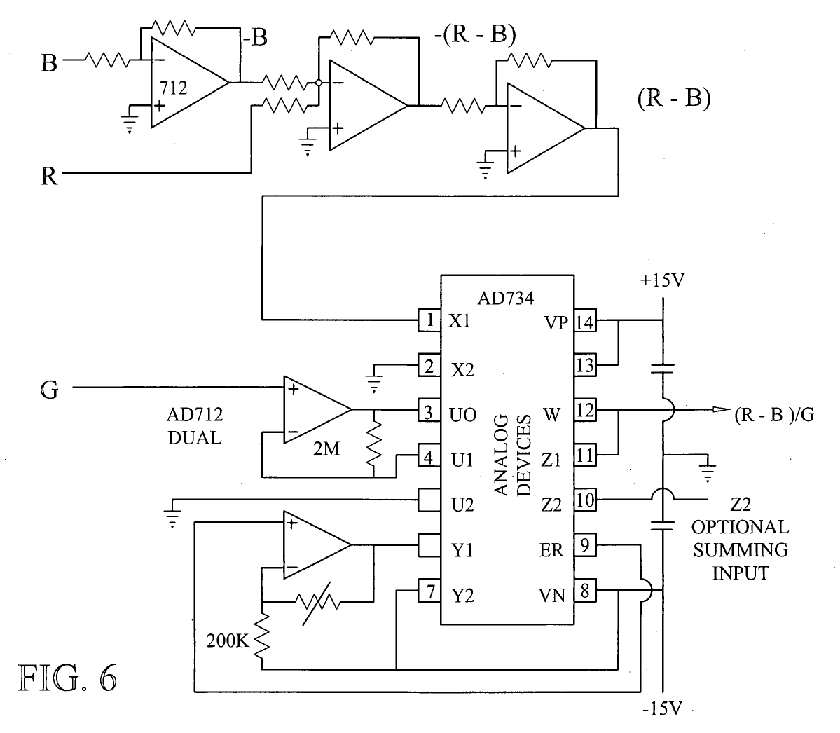

FIG. 5 is a flow chart of a logic process for determining the amount of focus shift. The process begins at the START bubble 88. The process follows the initial steps and functions of FIG. 2 as the process advances to block 90. Block 90 is a step to capture data for a color image frame. The step is performed by the Imager 32 in FIG. 2 and includes the process beginning with the formation of an image on the imager, followed by reading out the pixel and color intensity data for each pixel on the imager. Such imagers are available from companies such as the Sony Corporation. The process then advances to block 92 to the step of selecting ROI data from the data for a color image frame which is discussed above. In the next step 94, the process separates ROI data into R, G and P plane data. The process then advances to block 96 where the R, G and B data is used to calculate R, G and B image quality values for the present image. The process then advances to block 98, a measurement circuit as shown in FIG. 6, or preferably a computer process for measuring or calculating a present (R−B)/G present image quality signal difference quotient for the image on the imager 32.

The process then advances to block 100, a comparator circuit or more preferably a digital process for looking up or finding a best match of the present (R−B)/G image quality signal difference quotient with those values previously stored in an array of indexed values of (R−B)/G image quality quotients and corresponding FOCUS SHIFT distance and direction values. When the best match is found, the comparator circuit outputs or transfers the corresponding lens focus direction and distance via path 106. to the Lens Movement Control System 44 to move the lens in the direction and through the specified distance to obtain a best focus position of the lens in the least amount of time and without the steps and time normally associated with a slope chasing servo.

The comparator circuit of block 100, can be mechanized using a digital processor and a program. The function of block 100 is to determine the optimal focus movement value by referring to previously stored pairs of values in a memory array of indexed values of (R−B)/G image quality signal quotients and corresponding indexed lens focus distances from their respective best focus positions. With a calculated present value of (R−B)/G available, and with the present position of the lens known, the system refers to the previously stored look-up array of data and looks up the value of (R−B)/G image quality quotient that best matches the present value of (R−B)/G image quality signal difference quotient, The value of lens position corresponding to the best match value of image quality signal difference quotient is then transferred or output at block 104 to the Movement Control System 44 via signal path 106 for movement of the lens in the least amount of time to the best focus position. The process returns to the start bubble for the next iteration via path 108. In the alternative, the process can return to the start bubble 48 at the top of FIG. 3a.

FIG. 7 shows an analog circuit for calculating the image quality signal difference quotients (R−B)/G. As shown the left most operational amplifier is a unity gain inverter. The center amplifier sums the −B term and the R term to provide a result of −(R−B). The resulting term is inverted by the third amplifier to provide (R−B) which is then coupled to a first input to a two quadrant analog divider from the Analog Devices company. The G term is applied to a buffer amplifier and then pin 3. The (R−B) term is coupled to pin 1 on the divider. The result of (R−B)/G is obtained at pin 12. It should be understood that the process performed by the circuit of FIG. 7 could be performed by a digital computer running a program or routine. The signal values would be obtained in digital for for processing using analog to digital converter circuits. A sample rate would be established and latch registers would receive sample data at predetermined points in a control process under the control of a digital computer.

The difference function of (R−B)/G is used here for illustration purposes only. It is also possible to use other difference functions of R, G and B as long as the difference function varies monotonically with the focus shift distance in a predetermined manner. For example, one could use (R\hat{ }2−B\hat{ }2)/G\hat{ }2. The shape of the curve in FIG. 4 will be different. However, the new difference function is still monotonic vs. focus shift and the exact relation between the difference function and the focus shift can be pre-determined.

Those skilled in the art will appreciate that various adaptations and modifications of the preferred embodiments can be configured without departing from the scope and spirit of the invention. It is to be understood that the invention may be practiced other than as specifically described herein, within the scope of the appended claims.

What is claimed is:

1. An AF lens and process system for movement of a lens, while acquiring a color image, to obtain the best focus of the color image on the focal plane of an imager comprising:
a lens having a pre-determined amount of longitudinal chromatic aberrations (LCA), the lens focusing the color image on the focal plane of an imager, the imager providing an array of intensity values for the primary colors of Red (R). Green (G) and Blue (B),
a means responsive to the intensity values of each of the primary colors for calculating an R, G and B image quality signal, a means for comparing the values of the R, G and B image quality signals and,
a logic circuit for outputting a positive direction command to drive the lens in a positive direction if the B image quality signal is greater than the R image quality signal and to output a negative direction command to drive the lens in the opposite direction if the R image quality signal is greater than the B image quality signal.

2. The AF lens and process of claim 1 wherein the logic circuit for outputting a positive direction command signal or a negative direction command signal is further characterized to start executing a fine focus distance routine process if the G image quality signal is greater than the R image quality signal and if the G image quality signal is greater than the B image quality signal, the fine focus distance routine process providing a nudge drive signal to a Lens Movement Control System to moving the lens in a direction characterized to drive the lens to a position at which the R image quality signal substantially equals the B image quality signal.

3. An AF lens and process system for movement of a lens, while acquiring a color image, to obtain the best focus of the color image on the focal plane of an imager comprising:
providing a lens having a pre-determined amount of longitudinal chromatic aberrations (LCA), the lens focusing the color image on the focal plane of an imager, the imager providing an array of data values for the primary colors of Red (R), Green (G) and Blue (B),
providing a means for calculating an R, G and B image quality signal, and for calculating a present difference function based on the R, G and B image quality signals,
providing a means for comparing the present calculated difference function with previously stored calculated difference functions in an array of previously stored calculated difference functions with corresponding lens position distance value pairs and
finding a best match between the present calculated difference function and the previously stored calculated difference function, and outputting the corresponding lens position distance value to
a Lens Movement Control System for moving the lens to obtain a best focus position.

4. The AF lens and process system of claim 3 wherein the calculated difference function further comprises:
a process for subtracting the value of B from R and dividing the difference by the value of G.

5. The AF lens and process system of claim 3 wherein the calculated difference function further comprises:
a process for subtracting the value of the square of B from the square of R and dividing the difference by the value of the square of G.

6. An AF lens and process system for movement of a lens, while acquiring a color image, to obtain the best focus of the color image on the focal plane of an imager comprising:
a lens having a pre-determined amount of longitudinal chromatic aberrations (LCA) through an aperture, the lens focusing the color image on the focal plane of an imager, the imager providing an array of intensity values for the primary colors of Red (R). Green (G) and Blue (B),
a means responsive to the intensity values of each of the primary colors for calculating an R, G and B image quality signal,
a comparator circuit for comparing the values of the R, G and B image quality signals and,
a logic circuit for outputting a positive direction command to drive the lens in a first direction if the B image quality signal is greater than the R image quality signal and if the R image quality signal is greater than the G image quality signal.

7. The AF lens and process of claim 6 wherein the logic circuit for outputting a positive direction command is further characterized to output a negative direction command to drive the lens in a second direction if the R image quality signal is greater than the B image quality signal and if the R image quality signal is greater than the G image quality signal.

8. The AF lens and process of claim 6 further comprising:
an array of indexed values of (R−B)/G image quality signal quotients and corresponding indexed respective lens focus distances from a best focus position,
a measurement circuit for calculating the present value of the (R−B)/G image quality signal quotient for a present image, and
a comparator circuit for finding a best match of the present value of the (R−B)/G quotient with the indexed values of (R−B)/G quotients and transferring its indexed respective lens focus distances from a best focus position to
a Lens Movement Control System for moving the lens through a distance corresponding to the indexed respective lens focus distance to obtain a best focus position in the least amount of time.

9. The AF lens and process of claim 7 wherein the logic circuit for outputting a positive direction command signal or a negative direction command signal is further characterized to start executing a fine focus distance routine process if the G image quality signal is greater than the R image quality signal and if the G image quality signal is greater than the B image quality signal, the fine focus distance routine process providing a nudge drive signal to
a Lens Movement Control System to moving the lens in a direction characterized to drive the lens to a position at which the R image quality signal equals the B image quality signal.

10. The AF lens and process of claim 9 wherein the fine focus distance routine process further comprises the steps determining if the B image quality signal is equal to the R image quality signal, if the answer is YES, the process determines that the lens is IN FOCUS and the process optionally advances to the decision block to test to determine IS DISTANCE ROUTINE REQUIRED, if the answer is NO, the process advances to the step to determining if the R image quality signal is greater than the B image quality signal and if the answer is YES, the process nudges the lens in POSITIVE direction and the process optionally advances to the decision block to test to determine IS DISTANCE ROUTINE REQUIRED, if the process advances to the step to determine if the R image quality signal is greater than the B image quality signal and the answer is NO, the process advances to the step to determining if the B image quality signal is greater than the R image quality signal and if the answer is YES, the process nudges the lens in NEGITATIVE direction and the process optionally advances to the decision block to test to determine IS DISTANCE ROUTINE REQUIRED.

11. An AF lens and process system for movement of a lens, while acquiring a color image, to obtain the best focus of the color image on the focal plane of an imager comprising:
providing a lens having a pre-determined amount of longitudinal chromatic aberrations (LCA), the lens focusing the color image on the focal plane of an imager, the imager providing an array of data values for the primary colors of Red (R), Green (G) and Blue (B),
providing a means for calculating an R, G and B image quality signal, and for calculating a present difference function based on the R, G and B image quality signals,
providing a means for comparing the present calculated difference function with previously stored calculated difference functions in an array of previously stored calculated difference functions with corresponding lens position distance value pairs and
finding a best match between the present calculated difference function and the previously stored calculated difference function, and outputting the corresponding lens position distance value to
a Lens Movement Control System for moving the lens to obtain a best focus position.

12. The AF lens and process system of claim 11 wherein the calculated difference function further comprises:
a process for subtracting the value of B from R and dividing the difference by the value of G.

13. The AF lens and process system of claim 11 wherein the calculated difference function further comprises:
a process for subtracting the value of the square of B from the square of R and dividing the difference by the value of the square of G.
